(19) United States
(12) Patent Application Publication
(10) Pub. No.: US 2026/0340550 A1
(43) Pub. Date: Oct. 29, 2026

(54) RISK ASSESSMENT METHOD FOR SEDIMENT SILTATION INDUCED BY DEBRIS-FLOW BLOCKING PROJECTS IN MOUNTAINOUS SMALL WATERSHED

(71) Applicant: Institute of Mountain Hazards and Environment, Chinese Academy of Sciences, Sichuan (CN)

(72) Inventors: Jiangang CHEN, Sichuan (CN); Chenyuan WANG, Sichuan (CN); Yong YOU, Sichuan (CN); Hao SUN, Sichuan (CN); Fan WU, Sichuan (CN); Jinshui WANG, Sichuan (CN)

(21) Appl. No.: 19/656,317

(22) Filed: Apr. 23, 2026

(30) Foreign Application Priority Data
Apr. 28, 2025 (CN) 202510541036.9

(51) Int. Cl. G06Q 10/0635; G06Q 10/04; G06Q 50/08

(52) U.S. Cl. CPC G06Q 10/0635; G06Q 10/04; G06Q 50/08

(57) ABSTRACT

Provided is a risk assessment method for sediment siltation induced by blocking projects in a mountainous small watershed. Based on resilience disaster mitigation, a four-stage macroscopic analysis model is constructed from full-life-cycle perspective of blocking project measures, including advance preparation, resistance and absorption, response and adaptation and resilience recovery. The latter three risky stages are projected as three assessment windows, namely, pre-full siltation period, full siltation period, and post-full siltation period. Slope erosion and siltation hazard degree, blocking engineering structure vulnerability degree, and control measure resilience degree are introduced to assess risk levels of the three assessment windows; and flowing zone risk degree index is used to assess full-life-cycle comprehensive risk level. Based on microscopic analysis of material characteristics of dam-front deposits and disaster-causing evolution, the method establishes applicable assessment schemes for geotechnical and eco-geotechnical control measures by using a dam-front full-siltation time prediction model.

### CROSS-REFERENCE TO RELATED APPLICATION

This patent application claims the benefit and priority of Chinese Patent Application No. 202510541036.9 filed with the China National Intellectual Property Administration on Apr. 28, 2025, the disclosure of which is incorporated by reference herein in its entirety as part of the present application.

### TECHNICAL FIELD

The present disclosure relates to a disaster prevention and control technology for small mountainous watersheds, and in particular, to an assessment method for environmental governance by using debris-flow blocking projects in a small watershed, which belongs to the technical field of water conservancy engineering, data processing technologies specially applicable for environmental management, supervision or prediction purposes, as well as mountain disaster environmental governance technologies.

### BACKGROUND

The concept of “blocking” is one of the most important technical concepts in mountain environment governance for debris flow disaster prevention and control, specifically including two types of measures: blocking and blocking-diversion. In the flowing zone of the small mountainous watershed, various blocking projects, with a check dam and a sediment trapping dam as the primary forms, are the most intuitive embodiments of this technical concept. Blocking projects can not only block part of the solid-phase solids in debris flows and reduce debris flow scale, but also stabilize gully slopes, control gully erosion, and inhibit the development of debris flows, with remarkable effects on environmental governance in the small watersheds. However, as the debris flow disasters result from combined effects of various deep environmental factors in the small watershed formation zone, during the service life of the blocking projects, accumulation, siltation and deposition of sediment occur in a dam-front region of the gully under the influence of channel base flow and soil erosion on both bank slopes. This gradually changes environmental conditions such as a gully bed morphology, dam-front storage capacity, and dam-front hydrodynamic characteristics, while accumulating to form a huge accumulation-siltation deposition body, which becomes a new potential disaster factor.

In the prior art CN 2023105477054, an assessment method for a disaster risk induced by siltation behind a debris flow dam is provided. Based on results of full-process debris flow analysis and calculation by using smoothed particle hydrodynamics under different dam-rear siltation degrees, the scale of scour and siltation, flow depth, and flow discharge of the debris flow are used as key indexes for disaster mitigation assessment to achieve quantitative and dynamic assessment of the disaster risk induced by siltation behind the dam. This technology only solves the disaster risk assessment problem for the siltation behind the dam. The prior art CN2020105678882 has disclosed a method for hazard calculation of debris-flow dam-front back-silting accumulation body in blocking dam dismantling and application thereof, which provides a solution for quantitatively assessing potential hazards of the debris-flow dam-front back-silting accumulation body. However, this technology only solves the hazard of the dam-front back-silting accumulation body in blocking dam dismantling, but does not solve the hazard assessment problem of the back-silting accumulation body in longer spatial and temporal periods.

Among the different types of blocking projects for environmental governance in small mountainous watersheds, the dam-front deposition body gradually formed by the accumulation, siltation, and deposition of sediment and rock blocks continuously supplied from the gully and the bank slopes on both sides, and in particular, the type and level of disaster risk the dam-front deposition body poses to the blocking projects and the flowing zone of the small watershed within a longer time window of its formation and evolution, presents a new technical challenge that has not been concerned or solved in the existing technologies.

### SUMMARY

In view of the disadvantages of the prior art, an objective of the present disclosure is to provide a risk assessment technology for debris-flow blocking projects in a small mountainous watershed. During long-term service life of different types of blocking project measures in a flowing zone of the small mountainous watershed, different levels of assessment indexes are designed for disaster-causing effects on the small watershed due to the occurrence and evolution of the dam-front deposition, and a quantitative assessment scheme is further constructed.

To achieve the foregoing objective, the present disclosure provides a risk assessment method for sediment siltation induced by debris flow blocking projects in a mountainous small watershed, with a technical solution described below.

A risk assessment method for sediment siltation induced by debris flow blocking projects in a mountainous small watershed includes the following steps:
conducting field investigation of a flowing zone of a small watershed to obtain basic assessment data, where a field investigation region includes a planning zone for debris flow control project construction in the flowing zone;
estimating a vulnerability degree V of a blocking engineering structure by a vulnerability degree model, where in a full siltation period, the larger a value of V, the higher the vulnerability degree of the blocking engineering structure induced by a dam-front deposition body, and the higher a dam-break risk, and the vulnerability degree model is expressed as Equation 1:

V=σₜₒₜ/σ_{des} Equation 1
where σₜₒₜ denotes a total lateral pressure of the dam-front deposition body of the blocking engineering structure, in kN/m², which is determined according to the basic assessment data; and
σ_{des} denotes a design maximum bearing pressure of the blocking engineering structure, in kN/m², which is determined according to the basic assessment data.

In the foregoing risk assessment method for sediment siltation induced by debris flow blocking projects in the mountainous small watershed, the vulnerability degree V index of the blocking engineering structure is used to assess a disaster risk level of the flowing zone in the full-siltation period. In the full-siltation period, a lateral pressure of the dam-front deposition body may gradually exceed a limit value of a check dam structure, resulting in dam break. Therefore, in this stage, the vulnerability degree of the blocking engineering structure is a key potential disaster in the flowing zone.

During assessment, a risk level range of the vulnerability degree V of the blocking engineering structure may be divided as follows: 0<V≤0.2 indicates a low vulnerability degree, 0.2<V≤0.4 indicates a relatively low vulnerability degree, 0.4<V≤0.6 indicates a medium vulnerability degree, 0.6<V≤0.8 indicates a relatively high vulnerability degree, and 0.8<V≤1 indicates a high vulnerability degree.

Due to a large field measurement workload for σₜₒₜ, a measurement operation may increase disturbance to a dam structure and the dam-front deposition body. Therefore, the present disclosure provides a specific calculation model for σₜₒₜ based on the preliminary study, as expressed in Equation 2,

$$\{ \begin{matrix}{σ}_{tot} = μ \cdot {K}_{0} \cdot {σ}_{v} + {γ}_{w} {h}_{w} \\ μ = 1 + 0.1 {C}_{g} \cdot ( {D}_{50} / {D}_{90} ) \\ {K}_{0} = 1 - sin φ \\ {σ}_{v} = ( 1 - α ) {γ}_{d} H + α {γ}_{s} H\end{matrix} \qquad Equation 2$$

where μ denotes a correction factor; K₀ denotes a static earth pressure coefficient; and σᵥ denotes a vertical stress of the deposition body (kN/m²);
where parameters determined based on the basic assessment data include the follows: γ_{w} denotes unit weight of water (kN/m³); h_{w} denotes a water depth in the deposition body (m); C_{g} denotes a volume percentage of coarse particles in the deposition body (%); D₅₀ and D₉₀ denote reference particle sizes of solid particles in the deposition body (mm); φ denotes an internal friction angle of the deposition body (°); α denotes a volume weight factor; γ_{d} denotes a unit weight of a debris flow accumulation body (kN/m³); γₛ denotes a unit weight of a siltation body caused by bank slope runoff erosion (kN/m³); and H denotes a dam height of the blocking engineering structure (m).

An optimization scheme for the foregoing risk assessment method for sediment siltation induced by debris flow blocking projects in the mountainous small watershed further includes disaster risk assessment for the pre-full siltation period, specifically including: estimating a slope erosion and siltation hazard degree G by using a hazard degree model, where in the pre-full siltation period, the larger a value of G, the higher a contribution degree of the slope-eroded soil to an evolution process of the dam-front deposition body, and the higher the full-siltation risk; and the hazard degree model is expressed by Equation 3:

G=t₀/t Equation 3
where t₀ denotes a dam-front silting deposition time, in d, which is determined according to the basic assessment data; and
t denotes a dam-front full siltation prediction time under blocking control measures, in d, which is determined according to a t calculation scheme.

The foregoing t calculation scheme includes two schemes, which are respectively applicable to different types of blocking control measures. If the blocking control measures are geotechnical control measures, a first t calculation scheme is used, if the blocking control measures are eco-geotechnical control measures, a second t calculation scheme is used.

The first t calculation scheme is as follows: t is assigned a value of t₁, and t₁ is calculated according to Equation 4 and Equation 5;

$$\{ \begin{matrix}{t}_{1} = \frac{3 α {V}_{r}}{A {w}_{1}} \\ {V}_{r} = \frac{{H}^{2} B}{2 Δ J} \\ {w}_{1} = w {\vert}_{n = {n}_{1} , s = {s}_{1}}\end{matrix} \qquad Equation 4$$

$$w = \frac{1.17 \times 1 {0}^{4} {r}^{10 / 3} {J}^{5 / 2}}{{n}^{5} {s}^{3} {U}^{2} {D}^{1 / 2}} ; \qquad Equation 5$$

the second t calculation scheme: tis assigned a value of t₂, and t₂ is calculated according to Equation 5 and Equation 6;

$$\{ \begin{matrix}{t}_{2} = \frac{3 α {\sum }_{i = 1}^{N} {q}_{i}}{ρ A {w}_{2}} \\ {q}_{i} = \frac{1}{1000} λ L [ 16.14 ( 0.01 {P}_{i} + 0.02 ) - 0.03 ] \sqrt{1 + {J}^{2}} \\ {w}_{2} = w {\vert}_{n = {n}_{2} , s = {s}_{2}} \\ λ = {p}_{t} + 0.9 {p}_{h} + 0.8 {p}_{s}\end{matrix} \qquad Equation 6$$

where t₁ and t₂ are the dam-front full siltation prediction times under the action of geotechnical measures and eco-geotechnical measures, respectively; Vᵣ denotes a volume of a full-siltation deposition body (in m³); w denotes an average siltation rate of dam-front sediment (in m/d); w₁ and w₂ are the average siltation rates of the dam-front sediment under the action of the geotechnical measures and the eco-geotechnical measures, respectively; qᵢ denotes a soil runoff loss amount on a soil-and-water-eroded bank slope during an i^{th} rainfall event (in kg); and λ denotes a vegetation correction coefficient;
where parameters determined based on the basic assessment data include the follows: A denotes an upper surface area of the full-siltation deposition body (in m²), n denotes a bank slope roughness coefficient (dimensionless); n₁ and n₂ are the bank slope roughness coefficients under the action of the geotechnical measures and the eco-geotechnical measures, respectively; B denotes an average width of the full-siltation deposition body (in m); ΔJ denotes a gully longitudinal gradient full siltation variation (%); s denotes an average sediment concentration per unit cross-sectional volume of dam-front base flow (in kg/m³); s₁ and s₂ are the average sediment concentrations per unit cross-sectional volume of the dam-front base flow under the action of the geotechnical measures and the eco-geotechnical measures, respectively; r is an average hydraulic radius of a surface of the soil-and-water-eroded bank slope in the investigation region (in m); J denotes a longitudinal gradient of the surface of the soil-and-water-eroded bank slope in the investigation region (%); U denotes a dam-front average hydraulic radius (in m); D denotes an effective particle size of the sediment in the dam-front base flow (in mm); ρ denotes an average unit weight of the sediment in the dam-front base flow (in kg/m³); N denotes the number of rainfall events from empty storage to the assessment period; pₜ, pₕ, and pₛ denote percentages of arbor, herb, and shrub distribution areas in the investigation region (%); L denotes an orthographic area of the surface of the soil-and-water-eroded bank slope (in m²); and Pᵢ denotes rainfall of an i^{th} rainfall event within the N rainfall events (in mm).

In the pre-full siltation period, the disaster hidden danger is mainly caused by a dam-front accumulation, siltation and deposition rate. In the foregoing assessment method, the slope erosion and siltation hazard degree G index is used to evaluate a contribution degree of a sediment siltation body, flowed to the dam front by the surface runoff after the slope soil erosion, to the evolution of the dam-front deposition body. The higher the contribution degree, the higher the proportion of the surface-runoff-flowed sediment discharge in the dam-front deposition body, which means that the dam-front accumulation, siltation and deposition rate is more affected by daily water flow. Even when excluding the impacts of sudden large-scale material flowing events (such as debris flows, high-sediment-content flows, collapses, landslides), the dam-front full siltation risk remains high.

During the assessment, a risk level range of the slope erosion and siltation hazard degree G may be divided as follows: 0<G≤0.2 indicates a low hazard degree, 0.2<G≤0.4 indicates a relatively low hazard degree, 0.4<G≤0.6 indicates a medium hazard degree, 0.6<G≤0.8 indicates a relatively high hazard degree, and 0.8<G≤1 indicates a high hazard degree.

An optimization scheme of the foregoing risk assessment method for sediment siltation induced by debris flow blocking projects in the mountainous small watershed further includes disaster risk assessment for the post-full siltation period, specifically including: for the eco-geotechnical control measures, estimating a control measure resilience degree R by using a resilience degree model, where in the post-full siltation period, the larger a value of R, the higher a capability of the debris flow control measures for absorbing debris flow damage energy and conducting soil consolidation and sediment reduction, and the smaller the disaster risk in the flowing zone; and the resilience degree model is expressed in Equation 7,

$$\{ \begin{matrix}R = 0.3 NDVI + 0.3 VC + 0.4 {τ}_{c} \\ {τ}_{c} = {τ}_{c , RMD} / {τ}_{c , 0}\end{matrix} , \qquad Equation 7$$

where τ_{c} denotes a normalized critical shear strength at the beginning of soil erosion in the investigation region (in Pa); and
where parameters determined based on the basic assessment data include the follows: NDVI denotes a normalized vegetation index in the flowing zone (in dimensionless); VC denotes a vegetation coverage in the investigation region (%), τ_{c,RMD} denotes a critical shear strength of the soil in the investigation region under root mass density RMD (in Pa); and τ_{c,0} denotes a critical shear strength of bare soil in the investigation region (in Pa).

The full utilization of environmental improvement and restoration capacity of ecological measures is the reason that the eco-geotechnical control measures are introduced into the field of small watershed disaster prevention and control technologies and are increasingly valued. In the post-full siltation period, without the use of artificial disaster mitigation measures such as dredging, the disaster risk level of the flowing zone is primarily influenced by its own regulating capacity, as well as that of a small watershed ecosystem. In the post-full siltation period, a gully bed in the flowing zone undergoes intensified uplift and widening, gradually evolving into a main channel-floodplain two-element structure. In a region where the eco-geotechnical control is implemented, a two-element structure environment provides a favorable habitat for model communities during ecological restoration. Relying on constructed species communities and renewal capacity of the ecosystem in the ecological control means, the effects of the ecological measures on soil consolidation, sediment reduction, and deposition prevention, as well as rainfall interception and splash erosion mitigation, are gradually enhanced over time. These effects form resilient restoring capacity of the flowing zone to absorb disaster-induced damage energy, which can alleviate the risk of water and soil disasters in the small watershed, especially in downstream regions.

During the assessment, a risk level range of the control measure resilience degree R may be divided as follows: 0<R≤0.2 indicates a low resilience degree, 0.2<R≤0.4 indicates a relatively low resilience degree, 0.4<R≤0.6 indicates a medium resilience degree, 0.6<R≤0.8 indicates a relatively high resilience degree, and 0.8<R≤1 indicates a high resilience degree.

An optimization scheme of the foregoing risk assessment method for sediment siltation induced by debris flow blocking projects in the mountainous small watershed further includes comprehensive risk assessment of the flowing zone over the full life cycle of the blocking control engineering measures, specifically including: estimating a flowing zone risk degree I by using a risk degree model, where the lager a value of I, the larger a comprehensive disaster risk of the flowing zone during the full life cycle of the blocking control engineering measures; and the risk degree model is expressed in Equation 8, and for geotechnical control measures, R=0,

I=G·V·(1−R) Equation 8.

The flowing zone risk degree I characterizes a comprehensive disaster risk level of the flowing zone under the blocking control measures, viewed from a full-life-cycle perspective of the blocking control engineering measures, which is an entire service process including: advance preparation, resistance and absorption, response and adaptation, and resilience recovery.

During the assessment, a risk level range of the flowing zone risk degree I can be divided as follows: for the eco-geotechnical control measures, 0<I≤0.024 indicates a low risk, 0.024<I≤0.064 indicates a relatively low risk, 0.064<I≤0.128 indicates a medium risk, 0.128<I≤0.216 indicates a relatively high risk, and I>0.216 indicates a high risk; and for the geotechnical control measures, I≤0.04 indicates the low risk, 0.04<I≤0.16 indicates the relatively low risk, 0.16<I≤0.36 indicates the medium risk, 0.36<I≤0.64 indicates the relatively high risk, and I>0.64 indicates the high risk.

The inventive concept behind the above risk assessment method for sediment siltation induced by debris flow blocking projects in the mountainous small watershed provided by the present disclosure includes the following two groups of key concepts constructed based on theoretical analysis.

Concept group 1: Dam-front deposition body, dam-front accumulation body, and dam-front siltation body. The dam-front sediment and rock block deposit of a check dam is a mixture of sediment and rock blocks flowed by water flow from the flowing zone to the dam, and deposited and silted in front of the dam. Due to different water flow types, the material sources and their characteristics are different. In different operation periods of the check dam, with changes in the environment of the flowing zone, the scale and material composition of the dam-front deposit vary, leading to alterations in its structural and dynamic characteristics. To accurately describe the differences in attributes and evolution characteristics of the dam-front deposit in different stages, and accurately measure the dynamic characteristics of the dam-front deposit, the present disclosure constructs a set of concepts for describing the dam-front deposit, including a dam-front deposition body, a dam-front accumulation body, and a dam-front siltation body. The dam-front accumulation body refers to a deposit formed by sediment and rock blocks carried by debris flow and flowed to a dam-front region; the dam-front siltation body refers to a deposit formed by slope-eroded soil material flowed to the dam-front region via surface runoff, and the dam-front deposition body refers to a superimposed composite of the former two.

Concept group 2: Risk timeline stage and assessment period. When affected by external shocks, the small watershed system enters a resilience response process, and sequentially undergoes four stages: advance preparation, resistance and absorption, response and adaptation, and resilience recovery. The risk in the first stage can be negligible, and the latter three stages pose risks and exhibit timeline varying characteristics. To implement risk assessment, the latter three stages in the theoretical framework are projected as three assessment windows on an observation level, i.e., the pre-full siltation period, the full siltation period, and the post-full siltation period. The full siltation period refers to an observation period before and after the check dam reaches a full siltation state in practice; the pre-full siltation period refers to an observation period starting from the occurrence of dam-front accumulation, siltation and deposition to the onset of the full siltation period; and the post-full siltation period refers to an observation period following the full siltation period.

The term “field investigation” used in the present technology includes various geological surveys, reconnaissance, mapping, and measurement operations conducted at the small mountainous watershed site where the engineering measures are located, existing simulation experiments, testing experiments, observation experiments and analytical experiments in the field, the acquisition of historical disaster records, the relevant technical specifications, and the acquisition of empirical methods and data that can serve as a reference. The data obtained by the field investigation is collectively referred to as the basic assessment data of this technical solution.

Compared with the prior art, the present disclosure has beneficial effects as follows. (1) Planning and constructing blocking projects in a flowing zone of the small mountainous watershed is a modification of the hazard environment in the small watershed, with an objective of implementing disaster prevention and environment governance, which are complementary to each other. During the operation and service life of the blocking projects, the environmental conditions in the flowing zone change, and the environmental disaster risk level changes accordingly. The present disclosure provides a technical concept for long-term disaster risk assessment in the flowing zone of the small watershed with a service operation period of the blocking control engineering measures as a window period, which is used to assess the disaster risk under the blocking control engineering measures in the flowing zone of the small watershed, and is a new technical concept different from short-term hazard assessment in the prior art. With regard to the two major types of measures commonly used in debris flow prevention and control engineering, namely, purely geotechnical measures and combined eco-geotechnical measures, the assessment method provided by the present disclosure is based on different features of different service stages between the two measures, and specifically provides two different assessment schemes under the same technical concept. (2) The method provided by the present disclosure is based on the concept of resilient disaster mitigation. First, a complete four-stage macroscopic analysis model for service is built from a full-life-cycle perspective of the blocking control engineering measures. Then, microscopic analysis of the material source characteristics of the dam-front sand and rock deposit, along with disaster-causing evolution are further incorporated to establish a risk assessment scheme for the second to fourth stage windows. Based on previous analysis results of the influence of dam-front accumulation, siltation and deposition on the gully bed shape and hydrodynamic conditions, the assessment scheme takes dam-front full siltation under blocking control engineering measures as the core perspective to determine three assessment windows of the pre-full siltation period, the full siltation period, and the post-full siltation period at the observation level. Based on the constructed dam-front full-siltation time prediction model, three indexes of the slope erosion hazard degree G, the blocking engineering structure vulnerability degree V, and the control measure resilience degree R, are introduced to assess disaster attributes and levels of the flowing zone at the pre-full siltation period, the full siltation period, and the post-full siltation period. Based on this, the flowing zone risk degree I index is introduced to assess a comprehensive risk level under the full cycle perspective. (3) The technical solution of the present disclosure uses a planning area for debris-flow blocking projects in the flowing zone as an assessment environment, including a “three-element pattern zone” composed of gullies, floodplains, and bank slopes distributed with debris flow control engineering measures, and the environmental governance benefits of the debris flow control engineering measures on the flowing zone is placed within the full-life-cycle perspective of project operation and service. This is the first time that the problem of disaster risk assessment in the dynamic spatiotemporal condition of the flowing zone of the small mountainous watershed under blocking control measures has been proposed and addressed.

### BRIEF DESCRIPTION OF THE DRAWINGS

FIG. 1 is a diagram of risk assessment framework for sediment siltation induced by debris-flow blocking projects in a mountainous small watershed.

### DETAILED DESCRIPTION OF THE EMBODIMENTS

Preferred embodiments of the present disclosure are further described below with reference to accompanying drawings.

### Embodiment 1

Risk assessment is conducted for environmental governance of a flowing zone of a small mountainous watershed.

In the flowing zone of the small mountainous watershed, a debris flow check dam is built for environment governance. During ongoing operation of the project, long-term sediment flowing induced by daily sand-bearing flow and soil erosion on the slopes of both sides of the gully causes dam-front accumulation, siltation and deposition. The method provided by the present disclosure is used to assess a disaster risk level in the flowing zone of the small watershed.

### 1. Acquirement of Basic Data

Field investigation is conducted in the small watershed to obtain basic assessment data. A field investigation region is a planning zone for construction of debris flow control projects in the flowing zone, including gullies, floodplains, bank slopes, and the like.

Investigation has confirmed that the debris flow control measures in the flowing zone is a comprehensive control project with a check dam as a main body. The control measures are centered on a geotechnical structure of the check dam in the gully, and arbor, shrub and grass vegetation for environmental restoration and improvement are planted on the floodplains and bank slopes on both sides, thereby forming ecological engineering measurements. The debris flow control measures for the flowing zone belong to eco-geotechnical control measures.

The acquired basic assessment data are shown in Table 1 to Table 3. The classification of these data in the tables is not strict classification, and is only used to make the meaning of the listed data clear and easy to read. The same applies to the following description.

### 2. Assessment for a Debris-Flow Disaster Risk Level in the Small Watershed

To comprehensively assess the debris-flow disaster risk level at each stage throughout the full life cycle of the small watershed from the beginning of dam-front sediment accumulation, siltation, and deposition to the completion of environmental and ecological self-repairing achieved by the eco-geotechnical control measures during the operation of the foregoing check dam, four indexes are introduced in this embodiment for full-life-cycle risk assessment.

2.1 Assessment with a Slope Erosion and Siltation Hazard Degree Index G

A dam-front full-siltation prediction time t₂ under the blocking control is estimated by using the second t estimation scheme. Basic data are shown in Table 1.

TABLE 1
Basic assessment data 1 in Embodiment 1

| | | | Measured | |
|---|---|---|---|---|
| Classification | Object | Parameter index | value | |
| Bank slope | Soil-and-water | Roughness coefficient under eco- | 0.08 | |
| related | eroded bank | geotechnical measures, n₂ | | |
| | slope | Average hydraulic radius of slope, r | 0.02 | m |
| | | Average longitudinal gradient of slope, J | 750‰ | |
| | | Orthographic area of slope, L | 2 × 10⁷ | m² |
| Blocking | Dam-front base | Effective particle size of sediment, D | 3.00 | mm |
| engineering | flow | Average unit weight of sediment, ρ | 1800 | kg/m³ |
| structure | | Average sediment concentration per unit | 60 | kg/m³ |
| related | | cross-sectional volume under eco- | | |
| | | geotechnical measures, s₂ | | |
| Dam-front | Sedimentation | Dam-front accumulation and deposition | 180 | d |
| sediment | process | time, t₀ | | |
| accumulation, | parameters | Weight factor, α | 1 | |
| siltation and | Sedimentation | Average hydraulic radius, U | 0.60 | m |
| deposition | form | | | |
| related | Full-siltation | Upper surface area, A | 5000 | m² |
| | deposition body | Average width, B | 30 | m |
| | parameters | | | |
| Vegetation | Vegetation in | Vegetation correction coefficient, λ | 1 | |
| related | investigation zone | | | |
| Rainfall | Local rainfall | The number of rainfall events from | 80 | times |

| | | |
|---|---|---|
| related | empty storage to assessment period, N | |
| | Rainfall of an i^{th} rainfall event, Pᵢ | Omitted |

The parameters in Table 1 are determined by using a conventional investigation method. The roughness coefficient n₂ is queried in Table C.2.1-1 in NB/T 10139-2019 Specification for Investigation and Control Design of Debris Flow for Hydropower Projects, and s₂ is determined according to an in-situ measurement result, the number N of rainfall events and the rainfall Pᵢ are determined according to an observation record, and λ is determined is calculated based on the fourth formula in Equation 6 after obtaining percentages pₜ, pₕ, and pₛ of arbor, herb, and shrub distribution areas in the investigation region.

According to the parameters r, J, n₂, s₂, U, and D, the average siltation rate w₂ of the dam-front accumulation, siltation and deposition under the eco-geotechnical measures is calculated to be 0.03 m/d according to Equation 5 and the third formula in Equation 6. According to the parameters λ, L, J, and Pᵢ (taking a Pᵢ=80 mm as an example), the soil runoff loss amount qᵢ on a soil-and-water-eroded bank slope during the i^{th} rainfall event is determined to be 3.30×10⁵ Kg according to the second formula in Equation 6. According to the parameters N, qᵢ, ρ, A, and w₂, it is determined that t₂=0 d~293 d according to the first formula in Equation 6. In the model of Equation 6, a value of the weight factor α is assigned as follows: if no debris flow event occurs during the assessment period, α=1; if a single debris flow event is sufficient to fill entire storage capacity during the assessment period, α=0; and for other cases, α is determined based on a percentage value e of the storage capacity occupied by a volume of the dam-front deposition body during the assessment period, α=1−e.

Data t₂ and t₀ are substituted into Equation 3 to calculate the hazard degree G=0.61.

The assessment result G=0.61 indicates that since the onset of dam-front accumulation, siltation and deposition within the flowing zone, a dam-front accumulation formed by the sediment flowed from slope soil erosion during the pre-full siltation period has a relatively high contribution to the evolution of the dam-front deposition body. Even if no sudden large-scale sediment accumulation and siltation events occur in the small watershed, the risk of dam-front full siltation remains relatively high.

2.2 Assessment with a Blocking Engineering Structure Vulnerability Degree Index V

As actual field measurement of the total lateral pressure σₜₒₜ of the dam-front deposition body against the blocking engineering structure involves a large workload, the parameter is calculated by using a model in this embodiment. All parameter indexes in Table 2 are obtained by using a conventional measurement method.

TABLE 2
Basic assessment data 2 in Embodiment 1

| Classification | Object | Parameter index | Unit | |
|---|---|---|---|---|
| Blocking | Check dam | Dam height, H | 15 | m |
| engineering | structure | Design maximum bearing pressure, | 250 | kN/m² |
| structure related | | σ_{des} | | |
| Dam-front | Deposition | Water depth, h_{w} | 4 | m |
| sediment | body | Volume percentage of coarse | 25% | |
| accumulation, | parameters | particles, C_{g} | | |
| siltation | (including | Reference particle sizes of solid | 8 mm, 20 mm | |
| deposition | debris flow | particles, D₅₀ and D₉₀ | | |
| related | accumulation | Internal friction angle, φ | 30° | |
| | body and | Average unit weight of debris flow | 0 | |
| | siltation body | accumulation body, γ_{d} | | |
| | caused by | Average unit weight of siltation body | 15 | kN/m³ |
| | slope soil | caused by slope soil erosion, γₛ | | |
| | erosion) | | | |
| Constant | / | Unit weight of water γ_{w} | 9.8 | kN/m³ |

According to the parameters α=1, γ_{d}, H, γₛ, φ, C_{g}, D₅₀, D₉₀, γ_{w}, and h_{w}, the following items are calculated according to the model of Equation 2 as follows: the correction factor μ=1.01, the static earth pressure coefficient K₀=0.5, the vertical stress of the dam-front deposition body σᵥ=225 kN/m², and σₜₒₜ=152.87 Pa. According to σₜₒₜ and σ_{des}, the vulnerability degree Vis further determined to be 0.61 based on the model of Equation 1.

The assessment result V=0.61 indicates that during the period when the check dam would reach the dam-front full siltation period, that is, around the time when the storage capacity is in the full-siltation state, the probability of structural damage caused by the dam-front deposition body is relatively high, and the risk of dam break in the flowing zone is significant.

2.3 Assessment with a Control Measure Resilience Degree Index R

The parameters in Table 3 are obtained by using a conventional measurement method, where τ_{c,RMD} and τ_{c,0} are determined by using an in-situ test result.

TABLE 3
Basic assessment data 3

| | | | Measured |
|---|---|---|---|
| Classification | Object | Parameter index | value |
| Vegetation | Vegetation in | Normalized vegetation index, NDVI | 0.50 |
| related | investigation | Vegetation coverage, VC | 80% |
| | region | | |
| Soil | Soil in | Critical shear strength affected by root mass | 20000 Pa |
| | investigation | density RMD, τ_{c, RMD} | |
| | region | Critical shear strength of bare soil τ_{c, 0} | 35000 Pa |

According to the parameters τ_{c,RMD}, τ_{c,RMD}, NDVI, and VC, it is calculated according to the model of Equation 7 that τ_{c}=0.57 Pa and the resilience degree R=0.62.

The assessment result R=0.62 shows that, in the post-full siltation period, the debris flow control measures in the flowing zone have a high capability of absorbing the disaster damage energy, soil stabilization, and sand mitigation, which can alleviate the debris flow disaster risk in the small watershed to a certain extent.

2.4 Assessment with a Flowing Zone Risk Degree Index I

Scores of the indexes V, G, and R are substituted into the model of Equation 8, it is calculated the risk degree I=0.14, indicating that in this embodiment, the flowing zone of the small watershed is exposed to a relatively high comprehensive debris flow disaster risk throughout the full life cycle of the blocking control engineering measures.

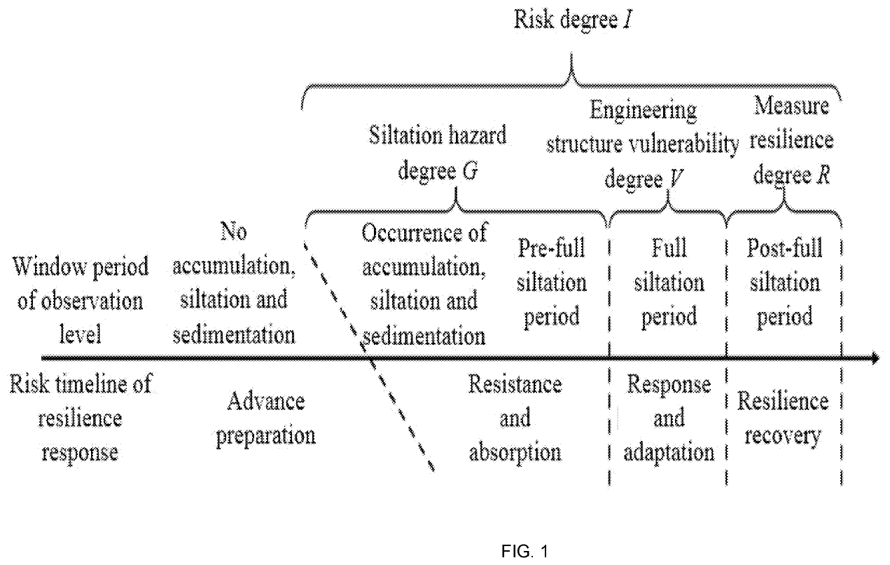

FIG. 1 is a diagram of a risk assessment framework for sediment siltation induced by the debris-flow blocking projects in the small mountainous watershed. In the FIGURE, a horizontal axis represents a service and operation duration of the debris flow blocking control engineering measures; a row labeled “Risk timeline of resilience response” below the horizontal axis indicates four stages of the risk timeline during a resilience response process of the small watershed system in the theoretical framework from a full-life-cycle perspective; a row labeled “Window period of observation level” above the horizontal axis represents window periods at which the four stages of the risk timeline in the theoretical framework are projected onto the observation level, among which the latter three are assessment windows; and the top of the “Window period of observation level” row shows a correspondence between the four assessment indexes and the assessment windows in the assessment method provided by the present disclosure.

### Embodiment 2

Risk assessment is conducted for environmental governance of a flowing zone of a small mountainous watershed.

In the flowing zone of the small mountainous watershed, a debris flow check dam is built for environment governance. During the ongoing operation of this project, dam-front accumulation, siltation and deposition phenomenon occurs. The method provided in the present disclosure is used to assess a disaster risk level in the flowing zone of the small watershed.

### 1. Acquirement of Basic Data

The basic assessment data are obtained by the same investigation method as described in Embodiment 1. It is confirmed that in this embodiment, the debris flow control measures in the flowing zone belongs to geotechnical control measures. The acquired basic assessment data are shown in Table 4 and Table 5.

### 2. Assessment for a Debris-Flow Disaster Risk Level in the Small Watershed

To comprehensively assess the risk level, three indexes are introduced in this embodiment for full-life-cycle risk assessment.

2.1 Assessment with a Slope Erosion and Siltation Hazard Degree Index G

A dam-front full-siltation prediction time t₁ under the blocking control is estimated by using the first t estimation scheme. Basic data are shown in Table 4.

TABLE 4
Basic assessment data 1 in Embodiment 2

| | | | Measured | |
|---|---|---|---|---|
| Classification | Object | Parameter index | value | |
| Gully related | Gully | Longitudinal gradient full siltation | 124‰ | |
| | | variation, ΔJ | | |
| Band slope | Soil-and-water | Roughness coefficient under | 0.07 | |
| related | eroded bank | geotechnical measures, n₁ | | |
| | slope | Average hydraulic radius of slope, r | 0.03 | m |
| | | Average longitudinal gradient of slope, | 75% | |
| | | J | | |
| Blocking | Dam-front base | Effective particle size of sediment, D | 4.00 | mm |
| engineering | flow | Average sediment concentration per | 80 | kg/m³ |
| structure | | unit cross-sectional volume under | | |
| related | | geotechnical measures, s₁ | | |
| | Check dam | Dam height, H | 15 | m |
| | structure | | | |
| Dam-front | Sedimentation | Dam-front accumulation and | 180 | d |
| sediment | process | deposition time, t₀ | | |
| accumulation, | parameter | | | |
| siltation and | Sedimentation | Average hydraulic radius, U | 0.60 | m |
| deposition | form | | | |
| related | Full-siltation | Upper surface area, A | 5000 | m² |
| | deposition body | Average width B | 30 | m |
| | parameters | | | |

The parameters in Table 4 are determined by using a conventional investigation method. The roughness coefficient n₁ is queried from Table C.2.1-1 in NB/T 10139-2019 Specification for Investigation and Control Design of Debris Flow for Hydropower Projects, s₁ is determined according to an in-situ measurement result, and ΔJ denotes the longitudinal gradient variation of the gully before and after full siltation.

A value of the weight factor α is determined by using the same method as described in Embodiment 1. According to the parameters r, J, n₁, s₁, U, D, ΔJ, H, B, W, and α=1, it is calculated according to the models of Equation 5 and Equation 4 that w₁=0.08 mid, Vᵣ=1.19 m/s, and t₁=204 d. Data t₁ and t₀ are substituted into formula 3 to calculate the hazard degree G=0.88.

2.2 Assessment with a Blocking Engineering Structure Vulnerability Degree Index V

TABLE 5
Basic assessment data 2 in Embodiment 2

| Classification | Object | Parameter index | Measured value | |
|---|---|---|---|---|
| Blocking | Check dam | Dam height, H | 15 | m |
| engineering | structure | Design maximum bearing pressure, | 250 | kN/m² |
| structure | | σ_{des} | | |
| related | | | | |
| Dam-front | Deposition | Water depth, h_{w} | 4 | m |
| (sediment) | body | Volume percentage of coarse | 30% | |
| accumulation, | parameters | particles, C_{g} | | |
| siltation and | (including | Reference particle sizes of solid | 10 mm, 25 mm | |
| deposition | debris flow | particles, D₅₀ and D₉₀ | | |
| related | accumulation | Internal friction angle, φ | 30° | |
| | body and | Average unit weight of debris flow | 0 | |
| | siltation body | accumulation body, γ_{d} | | |
| | caused by | Average unit weight of siltation | 15 | kN/m³ |
| | slope soil | body caused by slope soil erosion, | | |
| | erosion) | γₛ | | |
| Constant | / | Unit weight of water γ_{w} | 9.8 | kN/m³ |

By using the same method as described in Embodiment 1, the vulnerability degree V is calculated and determined to be 0.61 according to the vulnerability degree model.

2.3 Assessment with a Flowing Zone Risk Level Index I

Scores of the indexes V, G, and R=0 are substituted into the model of Equation 8, it is calculated the risk degree I=0.54, indicating that in this embodiment, the small watershed faces a relatively high comprehensive disaster risk in the full life cycle of the blocking control engineering measures.

What is claimed is:

1. A risk assessment method for sediment siltation induced by blocking projects in a mountainous small watershed, comprising:
conducting field investigation of a flowing zone of a small watershed to obtain basic assessment data, wherein a field investigation region comprises a planning zone for construction of a debris flow control project in the flowing zone;
estimating a vulnerability degree V of a blocking engineering structure by a vulnerability degree model, wherein in a full siltation period, a larger a value of V, a higher the vulnerability degree of the blocking engineering structure induced by a dam-front deposition body, and the higher a dam-break risk, and the vulnerability degree model is expressed as Equation 1:
$$V = {σ}_{tot} / {σ}_{des} \qquad Equation 1$$
$$\{ \begin{matrix}{σ}_{tot} = μ \cdot {K}_{0} \cdot {σ}_{v} + {γ}_{w} {h}_{w} \\ μ = 1 + 0.1 {C}_{g} \cdot ( {D}_{50} / {D}_{90} ) \\ {K}_{0} = 1 - sin φ \\ {σ}_{v} = ( 1 - α ) {γ}_{d} H + α {γ}_{s} H\end{matrix} \qquad Equation 2$$
wherein σₜₒₜ denotes a total lateral pressure of the dam-front deposition body of the blocking engineering structure, in kN/m², which is determined according to Equation 2;
σ_{des} denotes a design maximum bearing pressure of the blocking engineering structure, in kN/m², which is determined according to the basic assessment data;
μ denotes a correction factor;
K₀ denotes a static earth pressure coefficient;
σᵥ denotes a vertical stress of the deposition body, in kN/m²;
γ_{w} denotes unit weight of water, in kN/m³, which is determined based on the basic assessment data;
h_{w} denotes a water depth in the deposition body, in m, which is determined based on the basic assessment data;
C_{g} denotes a volume percentage of coarse particles in the deposition body, %, which is determined based on the basic assessment data;
D₅₀ and D₉₀ denote reference particle sizes of solid particles in the deposition body, in mm, which are determined based on the basic assessment data;
φ denotes an internal friction angle of the deposition body, in °, which is determined based on the basic assessment data;
α denotes a volume weight factor, which is determined based on the basic assessment data;
γ_{d} denotes a unit weight of a debris flow accumulation body, in kN/m³, which is determined based on the basic assessment data;
γₛ denotes a unit weight of a siltation body caused by bank slope runoff erosion, in kN/m³, which is determined based on the basic assessment data; and
H denotes a dam height of the blocking engineering structure, in m, which is determined based on the basic assessment data.

2. The risk assessment method for sediment siltation induced by blocking projects in the mountainous small watershed according to claim 1, wherein a value of the volume weight factor α is assigned as follows: if no debris flow event occurs during an assessment period, α=1; if a single debris flow event is sufficient to fill entire storage capacity during the assessment period, α=0; and for other cases, α is determined based on a percentage value e of the storage capacity occupied by a volume of the dam-front deposition body during the assessment period, α=1−e.

3. The risk assessment method for sediment siltation induced by blocking projects in the mountainous small watershed according to claim 1, wherein 0<V≤0.2 indicates a low vulnerability degree, 0.2<V≤0.4 indicates a relatively low vulnerability degree, 0.4<V≤0.6 indicates a medium vulnerability degree, 0.6<V≤0.8 indicates a relatively high vulnerability degree, and 0.8<V≤1 indicates a high vulnerability degree.

4. The risk assessment method for sediment siltation induced by blocking projects in the mountainous small watershed according to claim 1, further comprising: estimating a slope erosion and siltation hazard degree G by using a hazard degree model, wherein in a pre-full siltation period, the larger a value of G, the higher a contribution degree of slope-eroded soil to an evolution process of the dam-front deposition body, and the higher a full-siltation risk; and the hazard degree model is expressed by Equation 3;
G=t₀/t Equation 3
wherein t₀ denotes a dam-front silting deposition time, in d, which is determined according to the basic assessment data;
t denotes a dam-front full siltation prediction time under blocking control measures, in d, which is determined according to a t calculation scheme; wherein if the blocking control measures are geotechnical control measures, a first t calculation scheme is used, and if the blocking control measures are eco-geotechnical control measures, a second t calculation scheme is used;
the first t calculation scheme: t is assigned a value of t₁, and t₁ is calculated according to Equation 4 and Equation 5;
$$\{ \begin{matrix}{t}_{1} = \frac{3 α {V}_{r}}{A {w}_{1}} \\ {V}_{r} = \frac{{H}^{2} B}{2 Δ J} \\ {w}_{1} = w {\vert}_{n = {n}_{1} , s = {s}_{1}}\end{matrix} \qquad Equation 4$$
$$w = \frac{1.17 \times 1 {0}^{4} {r}^{10 / 3} {J}^{5 / 2}}{{n}^{5} {s}^{3} {U}^{2} {D}^{1 / 2}} ; \qquad Equation 5$$
the second t calculation scheme: t is assigned a value of t₂, and t₂ is calculated according to Equation 5 and Equation 6;
$$\{ \begin{matrix}{t}_{2} = \frac{3 α {\sum }_{i = 1}^{N} {q}_{i}}{ρ A {w}_{2}} \\ {q}_{i} = \frac{1}{1000} λ L [ 16.14 ( 0.01 {P}_{i} + 0.02 ) - 0.03 ] \sqrt{1 + {J}^{2}} \\ {w}_{2} = w {\vert}_{n = {n}_{2} , s = {s}_{2}} \\ λ = {p}_{t} + 0.9 {p}_{h} + 0.8 {p}_{s}\end{matrix} \qquad Equation 6$$
wherein, t₁ and t₂ are t under an action of the geotechnical measures and the eco-geotechnical measures, respectively;
Vᵣ denotes a volume of a full-siltation deposition body, in m³;
A denotes an upper surface area of the full-siltation deposition body, in m², which is determined based on the basic assessment data;
w denotes an average siltation rate of dam-front sediment, in m/d;
w₁ and w₂ are w under the action of the geotechnical measures and the eco-geotechnical measures, respectively;
n denotes a bank slope roughness coefficient, which is determined based on the basic assessment data;
n₁ and n₂ are n under the action of the geotechnical measures and the eco-geotechnical measures, respectively;
α denotes the volume weight factor;
H denotes the dam height of the blocking engineering structure, in m, which is determined based on the basic assessment data;
B denotes an average width of the full-siltation deposition body, in m, which is determined based on the basic assessment data;
ΔJ denotes a gully longitudinal gradient full siltation variation, %, which is determined based on the basic assessment data;
s denotes an average sediment concentration per unit cross-sectional volume of dam-front base flow, kg/m³, which is determined based on the basic assessment data;
s₁ and s₂ are s under the action of the geotechnical measures and the eco-geotechnical measures, respectively;
r denotes an average hydraulic radius of a surface of a soil-and-water-eroded bank slope in an investigation region, in m, which is determined based on the basic assessment data;
J denotes a longitudinal gradient of the surface of the soil-and-water-eroded bank slope in the investigation region, %, which is determined based on the basic assessment data;
U denotes a dam-front average hydraulic radius, in m, which is determined based on the basic assessment data;
D denotes an effective particle size of the sediment in the dam-front base flow, in mm, which is determined based on the basic assessment data;
ρ denotes an average unit weight of the sediment in the dam-front base flow, in kg/m³, which is determined based on the basic assessment data;
N denotes a number of rainfall events from empty storage to the assessment period, which is determined based on the basic assessment data;
qᵢ denotes a soil runoff loss amount on the soil-and-water-eroded bank slope during an i^{th} rainfall event, in kg;
λ denotes a vegetation correction coefficient;
pₜ, pₕ, and pₛ denote percentages of arbor, herb, and shrub distribution areas in the investigation region, %, which are determined based on the basic assessment data;
L denotes an orthographic area of the surface of the soil-and-water-eroded bank slope, in m², which is determined based on the basic assessment data; and
Pᵢ denotes rainfall of the i^{th} rainfall event in N rainfall events, in mm, which is determined based on the basic assessment data.

5. The risk assessment method for sediment siltation induced by blocking projects in the mountainous small watershed according to claim 4, wherein 0<G≤0.2 indicates a low hazard degree, 0.2<G≤0.4 indicates a relatively low hazard degree, 0.4<G≤0.6 indicates a medium hazard degree, 0.6<G≤0.8 indicates a relatively high hazard degree, and 0.8<G≤1 indicates a high hazard degree.

6. The risk assessment method for sediment siltation induced by blocking projects in the mountainous small watershed according to claim 4, further comprising for the eco-geotechnical control measures, estimating a control measure resilience degree R by using a resilience degree model, wherein in a post-full siltation period, the larger a value of R, the higher a capability of debris flow control measures for absorbing debris flow damage energy and conducting soil consolidation and sediment reduction, and a smaller a disaster risk in the flowing zone; and the resilience degree model is expressed in Equation 7,
$$\{ \begin{matrix}R = 0.3 NDVI + 0.3 VC + 0.4 {τ}_{c} \\ {τ}_{c} = {τ}_{c , RMD} / {τ}_{c , 0}\end{matrix} , \qquad Equation 7$$
wherein NDVI denotes a normalized vegetation index in the flowing zone, in dimensionless, which is determined based on the basic assessment data;
VC denotes a vegetation coverage in the investigation region, %, which is determined based on the basic assessment data;
τ_{c} denotes a normalized critical shear strength at beginning of soil erosion in the investigation region, in Pa;
τ_{c,RMD} denotes a critical shear strength of soil in the investigation region under root mass density RMD, in Pa, which is determined based on the basic assessment data; and
τ_{c,0} denotes a critical shear strength of bare soil in the investigation region, in Pa, which is determined based on the basic assessment data.

7. The risk assessment method for sediment siltation induced by blocking projects in the mountainous small watershed according to claim 6, wherein 0<R≤0.2 indicates a low resilience degree, 0.2<R≤0.4 indicates a relatively low resilience degree, 0.4<R≤0.6 indicates a medium resilience degree, 0.6<R≤0.8 indicates a relatively high resilience degree, and 0.8<R≤1 indicates a high resilience degree.

8. The risk assessment method for sediment siltation induced by blocking projects in the mountainous small watershed according to claim 6, further comprising estimating a flowing zone risk degree I by using a risk degree model, wherein a lager a value of I, a larger a comprehensive disaster risk of the flowing zone during a full life cycle of blocking control engineering measures; and the risk degree model is expressed in Equation 8,
I=G·V·(1−R) Equation 8,
wherein G denotes the slope erosion and siltation hazard degree;
V denotes the vulnerability degree of the blocking engineering structure; and
R denotes the control measure resilience degree, and wherein for the geotechnical control measures, R=0.

9. The risk assessment method for sediment siltation induced by blocking projects in the mountainous small watershed according to claim 8, wherein for the eco-geotechnical control measures, 0<I≤0.024 indicates a low risk, 0.024<I≤0.064 indicates a relatively low risk, 0.064<I≤0.128 indicates a medium risk, 0.128<I≤0.216 indicates a relatively high risk, and I>0.216 indicates a high risk; and for the geotechnical control measures, I≤0.04 indicates the low risk, 0.04<I≤0.16 indicates the relatively low risk, 0.16<I≤0.36 indicates the medium risk, 0.36<I≤0.64 indicates the relatively high risk, and I>0.64 indicates the high risk.

10. The risk assessment method for sediment siltation induced by blocking projects in the mountainous small watershed according to claim 2, wherein 0<V≤0.2 indicates a low vulnerability degree, 0.2<V≤0.4 indicates a relatively low vulnerability degree, 0.4<V≤0.6 indicates a medium vulnerability degree, 0.6<V≤0.8 indicates a relatively high vulnerability degree, and 0.8<V≤1 indicates a high vulnerability degree.

11. The risk assessment method for sediment siltation induced by blocking projects in the mountainous small watershed according to claim 2, further comprising: estimating a slope erosion and siltation hazard degree G by using a hazard degree model, wherein in a pre-full siltation period, the larger a value of G, the higher a contribution degree of slope-eroded soil to an evolution process of the dam-front deposition body, and the higher a full-siltation risk; and the hazard degree model is expressed by Equation 3;
G=t₀/t Equation 3
wherein t₀ denotes a dam-front silting deposition time, in d, which is determined according to the basic assessment data;
t denotes a dam-front full siltation prediction time under blocking control measures, in d, which is determined according to a t calculation scheme; wherein if the blocking control measures are geotechnical control measures, a first t calculation scheme is used, and if the blocking control measures are eco-geotechnical control measures, a second t calculation scheme is used;
the first t calculation scheme: t is assigned a value of t₁, and t₁ is calculated according to Equation 4 and Equation 5;
$$\{ \begin{matrix}{t}_{1} = \frac{3 α {V}_{r}}{A {w}_{1}} \\ {V}_{r} = \frac{{H}^{2} B}{2 Δ J} \\ {w}_{1} = w {\vert}_{n = {n}_{1} , s = {s}_{1}}\end{matrix} \qquad Equation 4$$
$$w = \frac{1.17 \times 1 {0}^{4} {r}^{10 / 3} {J}^{5 / 2}}{{n}^{5} {s}^{3} {U}^{2} {D}^{1 / 2}} ; \qquad Equation 5$$
the second t calculation scheme: t is assigned a value of t₂, and t₂ is calculated according to Equation 5 and Equation 6;
$$\{ \begin{matrix}{t}_{2} = \frac{3 α {\sum }_{i = 1}^{N} {q}_{i}}{ρ A {w}_{2}} \\ {q}_{i} = \frac{1}{1000} λ L [ 16.14 ( 0.01 {P}_{i} + 0.02 ) - 0.03 ] \sqrt{1 + {J}^{2}} \\ {w}_{2} = w {\vert}_{n = {n}_{2} , s = {s}_{2}} \\ λ = {p}_{t} + 0.9 {p}_{h} + 0.8 {p}_{s}\end{matrix} \qquad Equation 6$$
wherein, t₁ and t₂ are t under an action of the geotechnical measures and the eco-geotechnical measures, respectively;
Vᵣ denotes a volume of a full-siltation deposition body, in m³;
A denotes an upper surface area of the full-siltation deposition body, in m², which is determined based on the basic assessment data;
w denotes an average siltation rate of dam-front sediment, in m/d;
w₁ and w₂ are w under the action of the geotechnical measures and the eco-geotechnical measures, respectively;
n denotes a bank slope roughness coefficient, which is determined based on the basic assessment data;
n₁ and n₂ are n under the action of the geotechnical measures and the eco-geotechnical measures, respectively;
α denotes the volume weight factor;
H denotes the dam height of the blocking engineering structure, in m, which is determined based on the basic assessment data;
B denotes an average width of the full-siltation deposition body, in m, which is determined based on the basic assessment data;
ΔJ denotes a gully longitudinal gradient full siltation variation, %, which is determined based on the basic assessment data;
s denotes an average sediment concentration per unit cross-sectional volume of dam-front base flow, kg/m³, which is determined based on the basic assessment data;
s₁ and s₂ are s under the action of the geotechnical measures and the eco-geotechnical measures, respectively;
r denotes an average hydraulic radius of a surface of a soil-and-water-eroded bank slope in an investigation region, in m, which is determined based on the basic assessment data;
J denotes a longitudinal gradient of the surface of the soil-and-water-eroded bank slope in the investigation region, %, which is determined based on the basic assessment data;
U denotes a dam-front average hydraulic radius, in m, which is determined based on the basic assessment data;
D denotes an effective particle size of the sediment in the dam-front base flow, in mm, which is determined based on the basic assessment data;
ρ denotes an average unit weight of the sediment in the dam-front base flow, in kg/m³, which is determined based on the basic assessment data;
N denotes a number of rainfall events from empty storage to the assessment period, which is determined based on the basic assessment data;
qᵢ denotes a soil runoff loss amount on the soil-and-water-eroded bank slope during an i^{th} rainfall event, in kg;
λ denotes a vegetation correction coefficient;
pₜ, pₕ, and pₛ denote percentages of arbor, herb, and shrub distribution areas in the investigation region, %, which are determined based on the basic assessment data;
L denotes an orthographic area of the surface of the soil-and-water-eroded bank slope, in m², which is determined based on the basic assessment data; and
Pᵢ denotes rainfall of the i^{th} rainfall event in N rainfall events, in mm, which is determined based on the basic assessment data.

12. The risk assessment method for sediment siltation induced by blocking projects in the mountainous small watershed according to claim 7, further comprising estimating a flowing zone risk degree I by using a risk degree model, wherein the lager a value of I, the larger a comprehensive disaster risk of the flowing zone during a full life cycle of blocking control engineering measures; and the risk degree model is expressed in Equation 8,
I=G·V·(1−R) Equation 8,
wherein G denotes the slope erosion and siltation hazard degree;
V denotes the vulnerability degree of the blocking engineering structure; and
R denotes the control measure resilience degree, and wherein for the geotechnical control measures, R=0.
